(19) United States
(12) Patent Application Publication
(10) Pub. No.: US 2009/0070130 A1
(43) Pub. Date: Mar. 12, 2009

(54) REPUTATION SCORING

(76) Inventors: Neelakantan Sundaresan, Mountain View, CA (US); Zeqian Shen, Alameda, CA (US)

Correspondence Address: SCHWEGMAN, LUNDBERG & WOESSNER/EBAY, P.O. BOX 2938, MINNEAPOLIS, MN, 55402, US

(21) Appl. No.: 12/107,250

(22) Filed: Apr. 22, 2008

Related U.S. Application Data
(60) Provisional application No. 60/971,904, filed on Sep. 12, 2007.

(51) Int. Cl. G06Q 99/00

(52) U.S. Cl. 705/1

(57) ABSTRACT

In one example embodiment, a system and method is shown that includes receiving a feedback score relating to a transaction engaged in by a user. The system and method also includes applying a weight to the feedback score based on weighting criteria to create a weighted feedback score. Further, generating a reputation score for the user based on the weighted feedback score may also be implemented. In an additional example embodiment, the system and method includes identifying a reputation score relating at least one neighbor of a user, the at least one neighbor of the user including another user with whom the user has engaged in a transaction. Further, the system and method includes ordering the reputation score relating to at least one neighbor of the user to create an ordered reputation score. Moreover, the system and method includes displaying the ordered reputation score.

### CROSS REFERENCE TO RELATED APPLICATIONS

This is a non-provisional patent application claiming priority under 35 USC §119(e) to U.S. Provisional Patent Application No. 60/971,904 entitled “SOCIAL NETWORK ANALYSIS” that was filed on Sep. 12, 2007, and which is incorporated by reference in its entirety.

### TECHNICAL FIELD

The present application relates generally to the technical field of feedback data processing and, in one specific example, the generation of seller or buyer reputation score.

### BACKGROUND

Feedback relating to a transaction engaged in by a buyer or seller may describe such things as the timeliness of payment, the manner of payment, the quality of the goods sold, or other information relating to the transaction. This feedback may be narrative in nature or a numeric rating. Further, this feedback may be specific to a particular transaction or series of transactions engaged in by a buyer or seller. A transaction may be a providing of goods or services, in exchange for remuneration.

### BRIEF DESCRIPTION OF THE DRAWINGS

Some embodiments are illustrated by way of example and not limitation in the figures of the accompanying drawings in which:

FIG. 1 is diagram of a system, according to an example embodiment, used to record feedback between buyers and sellers.

FIG. 2 is a screenshot of a Graphical User Interface (GUI), according to an example embodiment, illustrating a reputation score relating to a seller.

FIG. 3 is a GUI, according to an example embodiment, illustrating a feedback profile containing a reputation score.

FIG. 4 is a GUI, according to an example embodiment, illustrating a graph used to show the transactions and feedback regarding transactions for a particular buyer or seller.

FIG. 5 is a block diagram of a computer system, according to an example embodiment, used to generate a reputation score.

FIG. 6 is a flow chart showing a method, according to an example embodiment, used to generate a reputation score and to propagate an update to neighbors of the user for whom the reputation score has been generated.

FIG. 7 is a further illustration, according to an example embodiment, of the method used to generate a reputation score and to propagate an update to neighbors of the user for whom the reputation score has been generated.

FIG. 8 is a flow chart illustrating a method, according to an example embodiment, used to update a reputation score in real time.

FIG. 9 is flow chart illustrating the execution of operation, according to an example embodiment, that updates user data in the form of a reputation score, based upon extracted feedback and transaction data.

FIG. 10 is flow chart illustrating the execution of operation, according to an example embodiment, that propagates updates of weighting criteria values, through the neighbors of a user.

FIG. 11 is flow chart illustrating the execution of operation, according to an example embodiment, that propagates updates of reputation scores through neighbors of users.

FIG. 12 is a transaction graph, according to an example embodiment, showing transactions between various buyers or sellers.

FIG. 13 is a feedback matrix, according to an example embodiment, representing feedback scores for individual buyers or sellers.

FIG. 14 is a flow chart illustrating the execution of an operation, according to an example embodiment, used to generate a display of a spectrum of feedback scores relating to a particular user.

FIG. 15 is an example Relational Data Schema (RDS), according to an example embodiment, showing various data tables that may be used by the system of method shown herein.

FIG. 16 shows a diagrammatic representation of a machine in the form of a computer system, according to an example embodiment.

### DETAILED DESCRIPTION

Example methods and systems to generate a real-time reputation score based on persons with whom a buyer or seller transact are described herein. In the following description, for purposes of explanation, numerous specific details are set forth to provide a thorough understanding of example embodiments. It will be evident, however, to one of ordinary skill in the art that the various embodiments may be practiced without these specific details.

In some example embodiments, a system and method are shown that allow for the real-time evaluation of a buyer or seller's reputation in an online environment. This real-time evaluation may take the form of a reputation score. A reputation score may be a numeric value that reflects a buyer or seller's reputation based on the reputations of those with whom a buyer or seller transact business. In some example embodiments, the reputation score may be represented numerically, whereas, in other embodiments, the reputation score may be represented graphically.

This reputation score may be based on feedback received from those with whom the buyer or seller has transacted in the sale of goods or services and a weight attributed to this feedback based on certain weighting criteria associated with the parties supplying the feedback. Feedback (e.g., a feedback score) may be in the form of a “1” for positive feedback, a “0” for neutral feedback, or a “−1” for negative feedback. Feedback criteria may be applied in cases where, for example, if the party supplying the feedback has only been participating in the sale of good or services for a very limited time, then less weight may be given to their feedback. If, however, this party has been participating in the sale of good or services for a long period of time, then more weight may be given to their feedback. Further, for example, if a party has frequently sold goods and services, then more weight may be given to their feedback, whereas if a party has infrequently sold good and services, then less weight may be given to their feedback.

In some example embodiments, through the use of weighting criteria, types of buyers and sellers, and the value of the feedback they provide may be determined. For example, casual buyers or sellers may be distinguished from buyers or sellers seeking to artificially raise or lower their reputation score and those with whom they transact in the buying or selling of goods or services. Further, seasoned buyers or sellers may be distinguished from the causal buyer or seller and those seeking to artificially raise or lower a reputation score.

In some example embodiments, feedback may be aggregated in real-time to reflect the most recent transactions that a buyer or seller has engaged in with other buyer or sellers. These buyers or sellers with whom the buyer or seller has engaged in transactions may be referred to as neighbors of the buyer or seller. In one example embodiment, any transaction engaged in by a buyer or seller may change a reputation score that is generated based, in part, on the feedback received from buyer and sellers and the various weighting of this feedback.

In some example embodiments, the reputation score may be propagated so as to affect the reputation score of those buyer or sellers with whom another buyer or seller has transacted. That is, the reputation scores of neighbors of a buyer or seller may be changed by virtue of a change in the reputation of the buyer or seller. This change may be propagated from neighbor to neighbor to neighbor so long as two or more buyers or sellers have transacted in the sale of goods or services.

Additionally, in some example embodiments, this reputation score may be represented as a single score, whereas in other embodiments the reputation score may be part of a spectrum of scores organized and represented in a graphical structure. This graphical structure may be a graph organized in a star topology, where the hub of the graph is a buyer or seller, the edges of the graph reflecting feedback relating to transactions between the hub, and other buyers or sellers. These other buyers or sellers may be represented as nodes in the graph. These edges may be weighted reputation scores using the previously referenced weighting criteria. Further, the various edges, hub, and nodes may be distinguished visually through the use of different colors, patterns, shares, or other suitable ways of visually distinguishing these various edges, hub, and nodes. Additionally, in some example embodiments, other types of graphical structures may be used, such as a line representing a spectrum.

Further, in some example embodiments, these reputation scores may be ranked to assist in the prediction of buyer or seller behavior. For example, if a reputation score is high relative to the reputation scores of other buyers or sellers, this ranking may be a predictor of the quality of the transaction engaged in by the buyer or seller.

### Example System

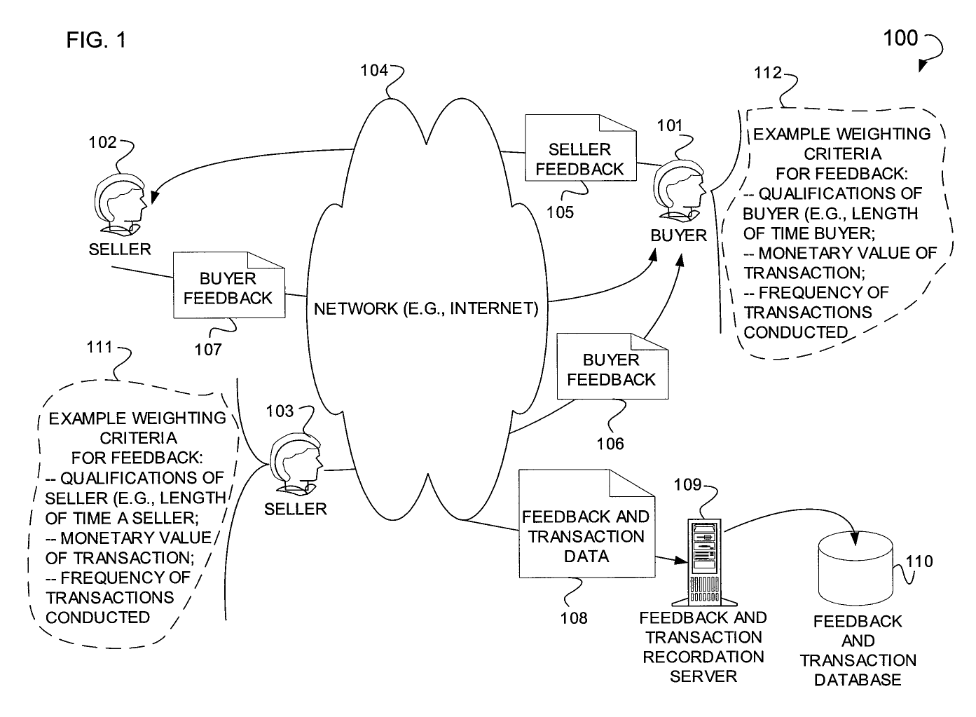

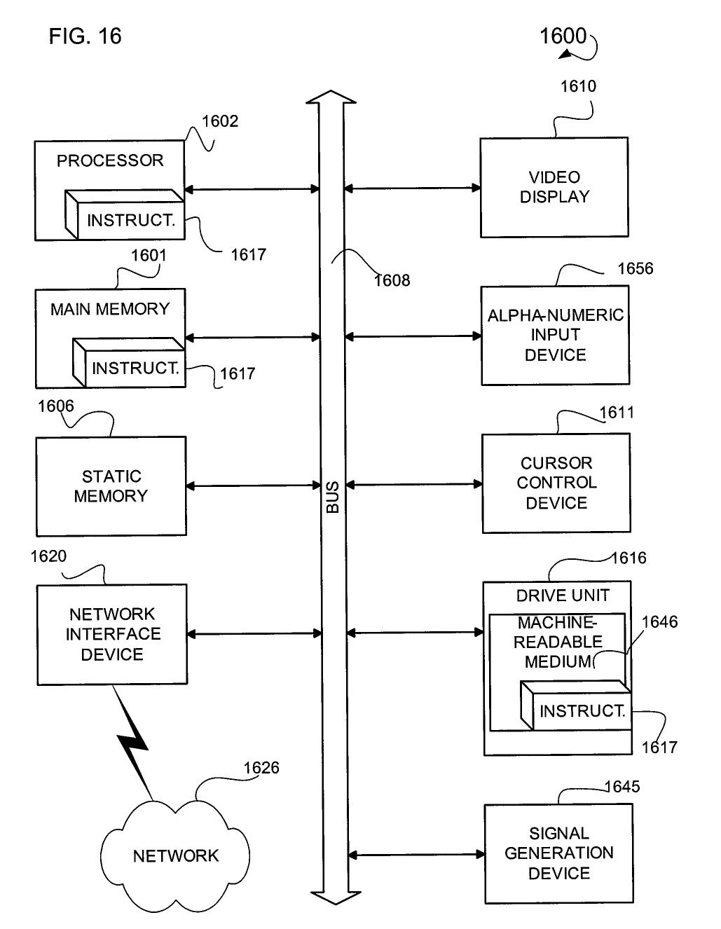

FIG. 1 is diagram of example system 100 used to record feedback between buyers and sellers. Shown is buyer 101 who generates seller feedback 105. This seller feedback 105 may be transmitted across a network 104 to be received by a seller 102. This network 104 may be the Internet or other suitable network. Further, the seller 102 may generate buyer feedback 107 that is then transmitted across the network 104 to be received by the buyer 101. Additionally, a seller 103 is shown that may generate buyer feedback 106 that may be transmitted across the network 104 to be received by the buyer 101. In some embodiments, the buyer 101, seller 102, and seller 103 may use a computer system (not shown) to generate the respective seller feedback 105, buyer feedback 107, and buyer feedback 106. This computer system may be a cell phone, Personal Digital Assistant (PDA), smart phone, television or monitor, a computer system as outlined below in FIG. 16, or other suitable device. Monitoring the network 104, and the seller feedback 105, buyer feedback 107, and buyer feedback 106, may be a feedback and transaction recordation server 109. This feedback and transaction recordation server 109 may exist as part of a website where goods and services are sold. Such as website may include an online auction website.

This feedback and transaction recordation server 109 may monitor the various buyer and seller feedbacks that are transmitted across the network 104. In some example embodiments, a web server may receive the seller feedback 105, buyer feedback 107, and buyer feedback 106 (collectively referenced as feedback) and transmit this feedback to the transaction recordation server 109. Further, this monitoring may take the form of feedback and transaction data 108 that is extracted, or pulled off, the network 104 and stored by the feedback and transaction recordation server 109 into a feedback and transaction database 110. Some example embodiments may include the use of a database server to store the feedback and transaction data 108 into the feedback and transaction database 110.

In some example embodiments, various weighting criteria for feedback may be used to weight the seller feedback 105, the buyer feedback 107, or the buyer feedback 106. For example, shown is weighting criteria for feedback 112 where this weighting criteria for feedback 112 includes the qualifications of a buyer. These qualifications may include the length of time that one is a buyer, the monetary value of a transaction based on which feedback is generated, or the frequency of transactions conducted by, for example, the buyer 101. This weighting criteria for feedback may be used, in some cases, to determine the value of feedback. If the feedback is, for example, negative feedback (e.g., represented as a “−1”), neutral feedback (e.g., “0”), or positive feedback (e.g., “1”), this weighting criteria may be used to evaluate this feedback. In some example embodiments, this evaluation may take the form of finding the product of the weighting criteria and the feedback value.

In some example embodiments, these same weighting criteria for feedback may be used by a seller such as seller 102. Shown as weighting criteria for feedback 111 are a number of weighting criteria for feedback used by, for example, the seller 103. These criteria include, for example, the qualifications of a seller (e.g., the length of time that one is a seller), the monetary value of transactions engaged by the seller 103 and/or the frequency of transactions conducted by the seller 103.

### Example Interface

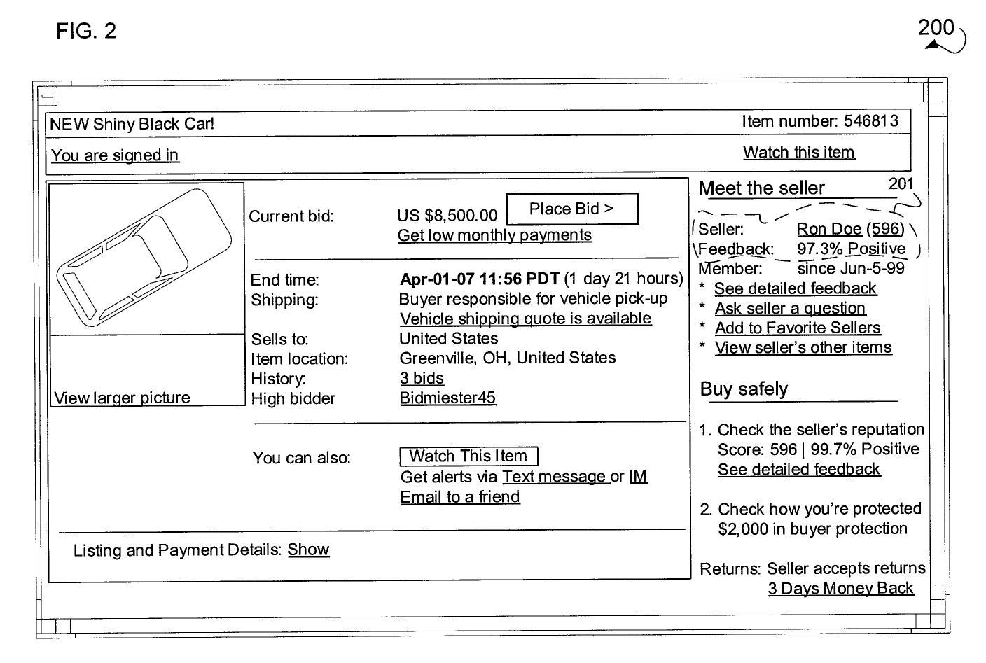

FIG. 2 is a screenshot of an example GUI 200 illustrating a reputation score relating to a seller. Shown is a field 201 containing the name of a seller, which in this case is Ron Doe, and a feedback percentage value for this seller, which here is 97.3 percent positive. This feedback percentage value may be used to determine the amount of positive or negative or neutral feedback for a particular seller or buyer. Also included in this field 201 is a reputation score for the seller, which is listed here as 596. One example way in which this reputation score is generated may be more fully illustrated below.

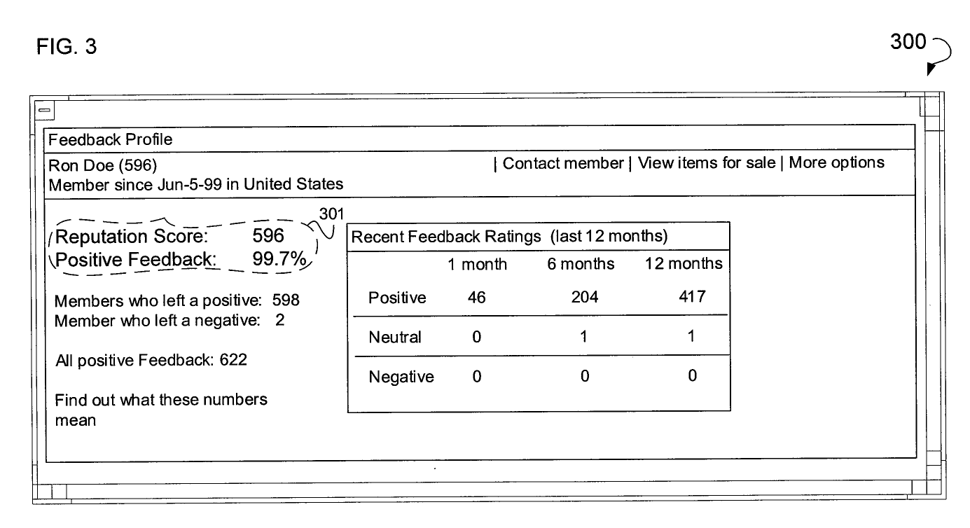

FIG. 3 is an example GUI 300 illustrating an example feedback profile containing a reputation score. Shown is a field 301 containing or otherwise illustrating the reputation score for the seller Ron Doe. This reputation score is listed as 596. Also shown is positive feedback percentage for this seller, which is 97.5. As stated elsewhere, this reputation score may be represented graphically in any one of a number of ways.

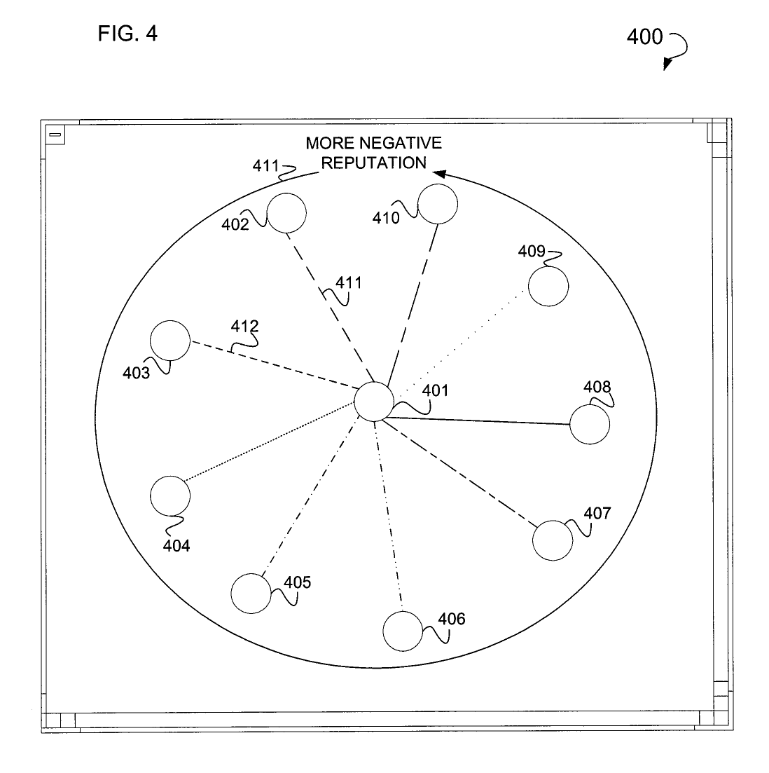

FIG. 4 is a GUI 400 illustrating a graph used to show the transactions and feedback regarding transactions for a particular buyer or seller. This feedback may be collectively understood as a reputation score for a particular buyer or seller. Here, for example, a graph is shown having a star topology. As a part of this star topology, a hub node 401 is shown that represents a particular buyer or a seller (e.g., Ron Doe). Associated with this hub node 401 are a number of other nodes representing other buyers or sellers with whom the buyer or seller 401 has transacted. This hub node 401 is connected to these other nodes via a plurality of edges. These edges represent types or degrees of feedback tending to be more or less positive or neutral. For example, connected to the hub node 401 is a node 402. This hub node 401 is connected to the node 402 via an edge 411 where this edge 411 represents the most positive feedback that the seller or buyer represented by hub node 401 has received. These various edges and nodes may be represented via different colors, patterns, or shapes associated with edges or nodes to denote or signify characteristics of the node and/or edges. Also shown is a node 403 that is connected to the hub node 401 via an edge 412. This edge 412 has a pattern that is distinct from the other edges that connect nodes to the hub node 401. Relative to the edge 411, the edge 412 denotes slightly more negative feedback relating to the buyer or seller represented by the hub node 401. Also shown are a number of other nodes representing buyers or sellers that have transacted with hub node 401. These other nodes include nodes 404 through node 410. Node 410 represents a buyer or seller who has provided the most negative feedback with regard to hub node 401.

In some example embodiments, as one traverses in a counter-clockwise manner through the star topology (see e.g., traversal 411) more negative feedback is provided. In other example embodiments, the traversal may be in a clockwise movement denoting, for example, more negative feedback or more positive feedback. The star topology illustrated here and it is for illustrative purposes, and another type of topology may be implemented to show a spectrum of negative feedback or positive feedback. Further, in some example embodiments, nodes with similar feedback may be clustered (e.g., aggregated) and connected with a single edge.

### Example Logic

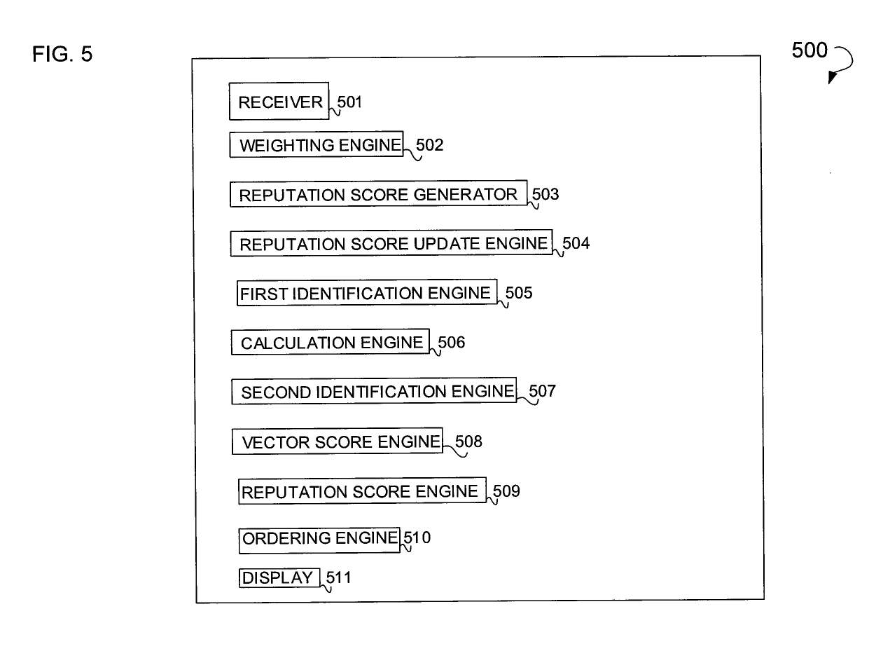

FIG. 5 is a block diagram of a computer system 500 used to generate a reputation score. This computer system 500 may be the feedback and recordation server 109. The various blocks shown herein may be implemented in software, firmware, or hardware. Illustrated is a receiver 501 to receive a feedback score relating to a transaction engaged in by a user. A weighting engine 502 is also shown to apply a weight to the feedback score, based on weighting criteria, to create a weighted feedback score. In some example embodiments, a weighted feedback score is the product of the weighting criteria and the feedback score. A reputation score generator 503 is shown to generate a reputation score for the user based on the weighted feedback score. Additionally, a reputation score update engine 504 is illustrated to update a reputation score of a neighbor of the user using the reputation score for the user, the neighbor that includes another user with whom the user has engaged in a transaction. Further, in some example embodiments, a first identification engine 505 is shown to identify a weighted feedback score for at least one neighbor, the at least one neighbor that includes another user with whom the user has engaged in a transaction. A calculation engine 506 is shown to determine a sum of the weighted feedback score for the at least one neighbor. In addition, a second identification engine 507 is illustrated to identify the reputation score for the user through a determination of a sum of the weighted feedback score for the at least one neighbor and a seed value. Some example embodiments may include the weighting criteria including at least one of a qualification of another user, a monetary value of a transaction engaged in by another user, or a frequency of transactions conducted by another user. Moreover, a vector score engine 508 may be implemented to determine a vector score by finding a product of a further vector score and a feedback matrix, the feedback matrix including at least one feedback score from at least one user. In some example embodiments, the vector score includes a product of the weighted feedback score and the reputation score. Some example embodiments may include the feedback matrix as an adjacency matrix.

In some example embodiments, the computer system 500 may include various blocks 509 through 511. These blocks may reside on the feedback and transaction recordation server 109 or these blocks may reside on any one of a number of other devices. These other devices may include a cell phone, PDA, smart phone, television or monitor, or other suitable device. Additionally, these blocks may exist as software, firmware, or hardware. Shown is a reputation score engine 509 to identify a reputation score relating at least one neighbor of a user, the at least one neighbor of the user that includes another user with whom the user has engaged in a transaction. An ordering engine 510 is shown to order the reputation score that relates to at least one neighbor of the user to create an ordered reputation score. A display 511 is shown to display the ordered reputation score. In some example embodiments, the order includes an order from highest to lowest reputation score, or order from lowest to highest reputation score. Additionally, the display 511 may include a display to display a graph that includes a node and an edge, the node to include the reputation score for at least one neighbor, and the node and the edge distinguished by at least one distinguishing characteristic that includes a color, a shape, or a pattern.

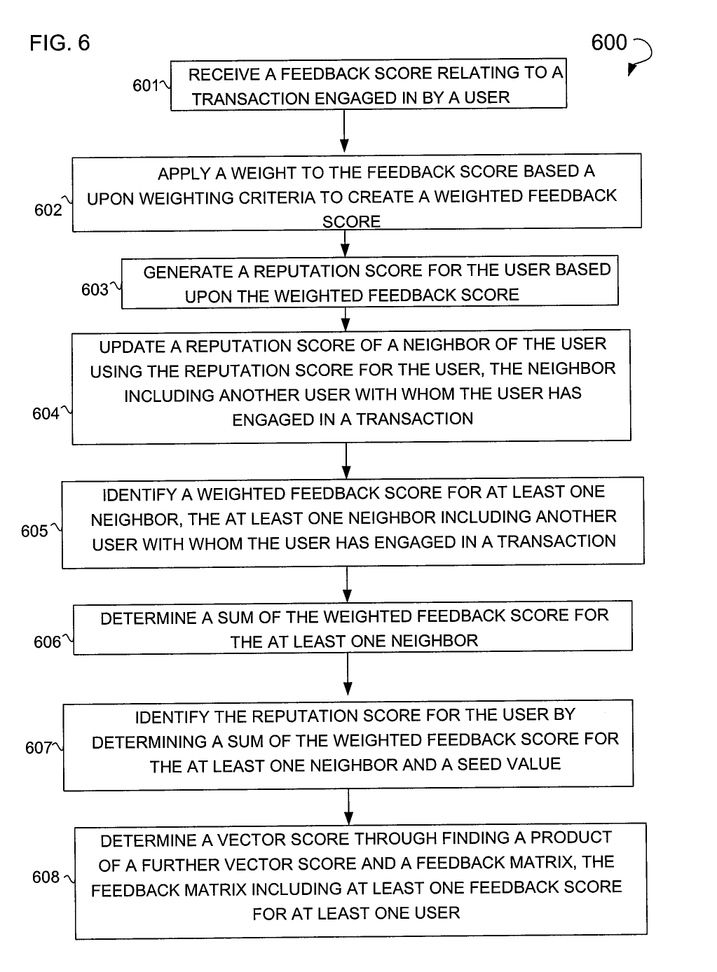

FIG. 6 is a flow chart showing an example method 600 used to generate a reputation score and to propagate this update to neighbors of the user for whom the reputation score has been generated. Shown are operations 601 through 608 that may be executed by the feedback and transaction recordation server 109 and/or other computer systems including a cell phone, PDA, television or monitor, or smart phone. Illustrated is an operation 601 that, when executed, receives a feedback score relating to a transaction engaged in by a user. An operation 602 is shown that, when executed, applies a weight to the feedback score based on weighting criteria to create a weighted feedback score. An operation 603 is shown that, when executed, generates a reputation score for the user based on the weighted feedback score. Further, an operation 604 is illustrated that, when executed, updates a reputation score of a neighbor of the user using the reputation score for the user, the neighbor including another user with whom the user has engaged in a transaction. An operation 605 may be executed so as to identify a weighted feedback score for at least one neighbor, the at least one neighbor including another user with whom the user has engaged in a transaction. An operation 606 may be executed to determine a sum of the weighted feedback score for the at least one neighbor. Operation 607 may be executed to identify the reputation score for the user by determining a sum of the weighted feedback score for the at least one neighbor and a seed value. In some example embodiments, the weighting criteria includes at least one of a qualification of another user, a monetary value of a transaction engaged in by another user, or a frequency of transactions conducted by another user. Operation 608 may be executed to determine a vector score through finding a product of a further vector score and a feedback matrix, the feedback matrix including at least one feedback score for at least one user. In some example embodiments, the further vector score includes a product of the weighted feedback score and the reputation score. Some example embodiments may include the feedback matrix as an adjacency matrix.

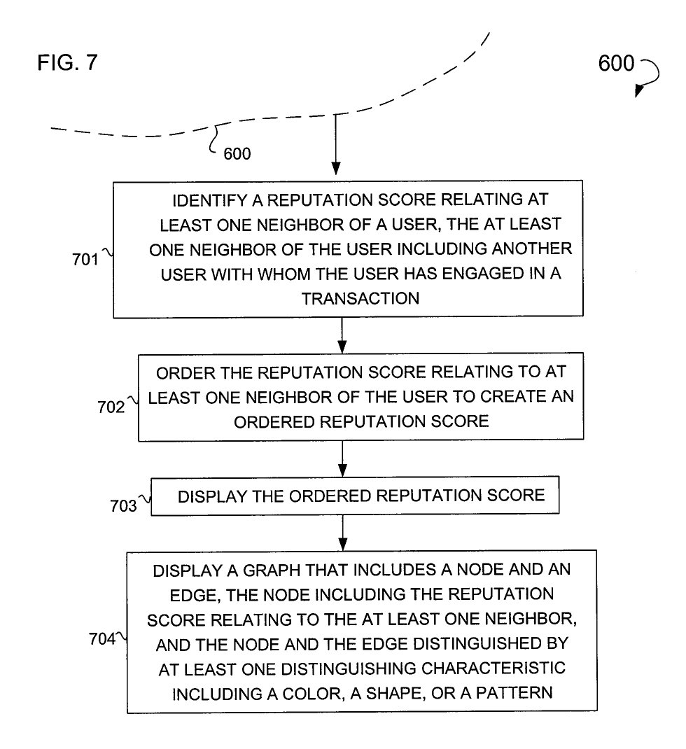

FIG. 7 is a further illustration of method 600 that may include additional operations. The operations 701 through 704 may be executed on the feedback and transaction recordation server 109, a cell phone, PDA, television or monitor, or other suitable device. An operation 701, when executed, may include identifying a reputation score relating at least one neighbor of a user, the at least one neighbor of the user including another user with whom the user has engaged in a transaction. Further, an operation 702 may include, when executed, ordering the reputation score relating to at least one neighbor of the user to create an ordered reputation score. An operation 703, when executed, may include displaying the ordered reputation score. In some example embodiments, the ordering includes ordering the reputation score in an order including at least one of ordering by highest to lowest reputation score or ordering by lowest to highest reputation score. Some example embodiments may include the operation 704, that when executed displays a graph that includes a node and an edge, the node including the reputation score relating to the at least one neighbor, and the node and the edge distinguished by at least one distinguishing characteristic including a color, a shape, or a pattern.

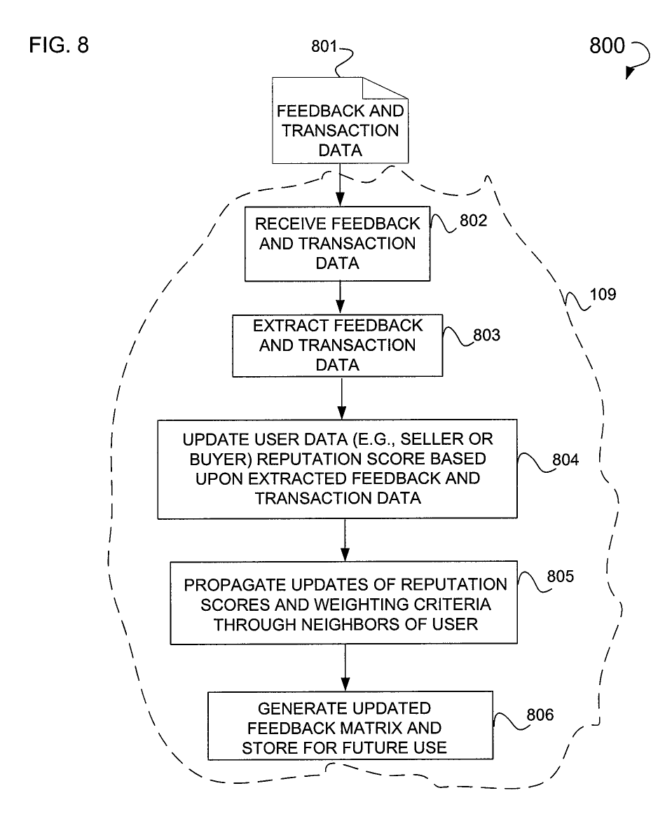

FIG. 8 is a flow chart illustrating an example method 800 used to update a reputation score in real-time. In some example embodiments, a reputation score is updated in real-time when a change occurs in the form of a new transaction between a buyer and/or seller. As shown here, an operations 802 through 806 may reside on, for example, the feedback and transaction recordation server 109. Illustrated is feedback and transaction data 801 that is received through the execution of an operation 802. An operation 803 may be executed that extracts feedback and transaction data. Further, an operation 804 may be executed that updates user data in the form of a reputation score based on extracted feedback and transaction data. An operation 805 may be executed that may propagate the updates of reputation scores and weighting criteria through the neighbors of a user. These neighbors of the user may be those persons with whom the user has transacted. An operation 806 may be executed that may generate an updated feedback matrix and store this matrix for future use.

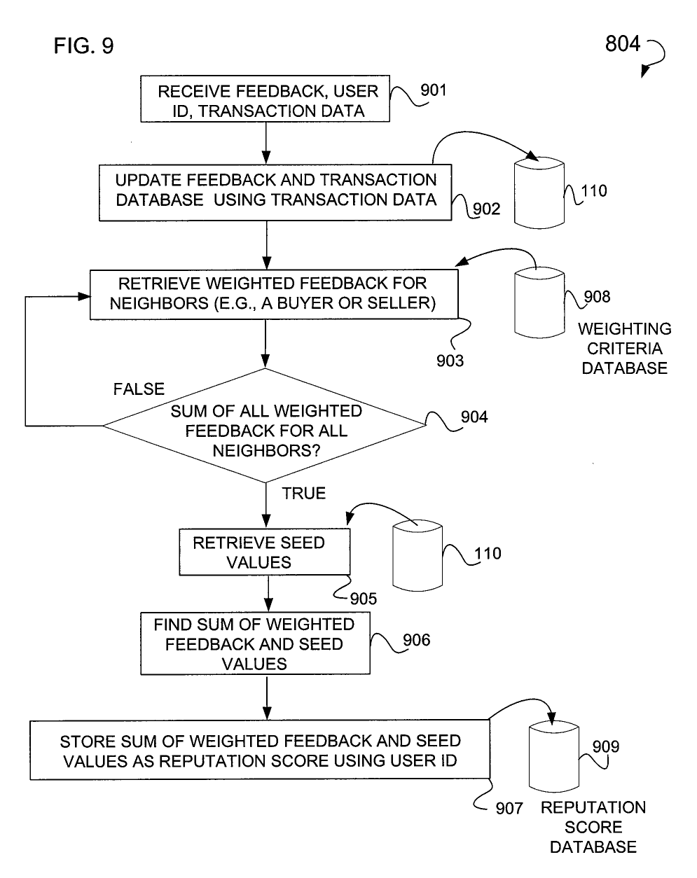

FIG. 9 is flow chart illustrating the example execution of operation 804. Shown is an operation 901 that, when executed, receives feedback data or user ID and transaction data. An operation 902 may be executed that may update the feedback and transaction database 110 using the transaction data. An operation 903 may be executed that may retrieve weighted feedback scores for neighbors of a user (e.g., a buyer or seller). These weighted feedback scores may be retrieved from, for example, a weighting criteria database 908. A decisional operation 904 may be executed that may determine whether or not the sum of all weighted reputations for all neighbors has been retrieved. In cases where decisional operation 904 evaluates to “false,” the operation 903 may be re-executed. In cases where decisional operation 904 evaluates to “true,” an operation 905 may be executed. This operation 905 may retrieve the seed values from, for example, the feedback and transaction database 110. An operation 906 may be executed that may find the sum of weighted reputations and seed values. An operation 907 may be executed that may store this sum or weighted reputations or seed values as a reputation score into the reputation score database 909. This reputation score may be stored based on a user ID value.

In some example embodiments, operation 804 in FIG. 8 may be represented as a reputation equation. A reputation equation may be implemented to generate a reputation score for an individual user. Among other properties, this reputation equation may be able to generate a reputation score based, in part, on the reputation of neighbors of a buyer or seller (e.g., a user referenced as “u”). An example of this reputation equation may be illustrated as follows:

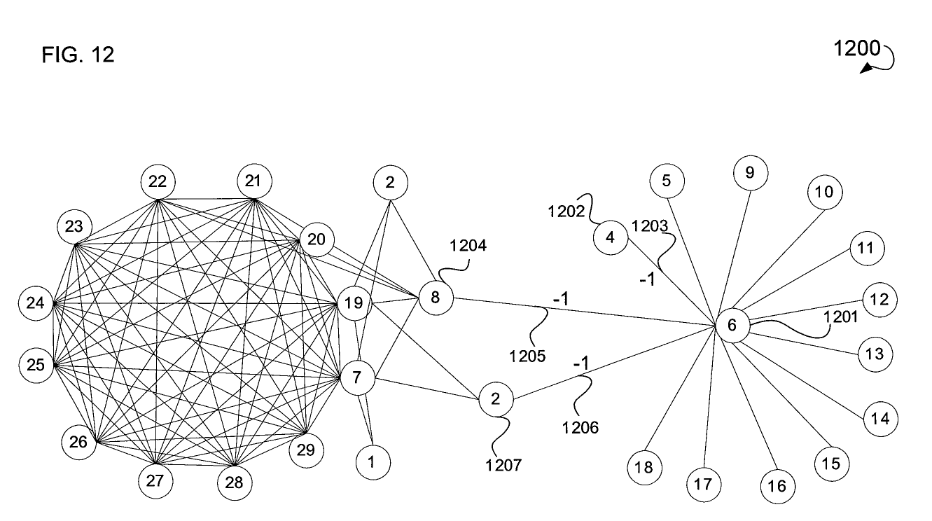

R(u)=cE(u)+ΣWij*R(v)*VεN(u)
where: VεN(u) is used to determine whether “V” is in the neighborhood of “u”;
   c is a heuristic constant;
   E(u) is a seed function containing data such as historical data, or start value data;
   ΣWij*R(v) is the product of reputations for each neighbor of “u”;
   Wij is the sum of each weighted reputation score for the user “u”;
   R(v) is the reputation for neighbors (e.g., “v”) of user “u”.
      In some example embodiments, Wij may be thought of as representing the weighing of a particular edge relating two neighbors in a graph. This relating of two or more neighbors in a graph may be represented in a matrix or in matrices (collectively referred to as a matrix), where Wij represents coordinates within the matrix. As shown in FIG. 12 below, this matrix or matrices may be an adjacency matrix.

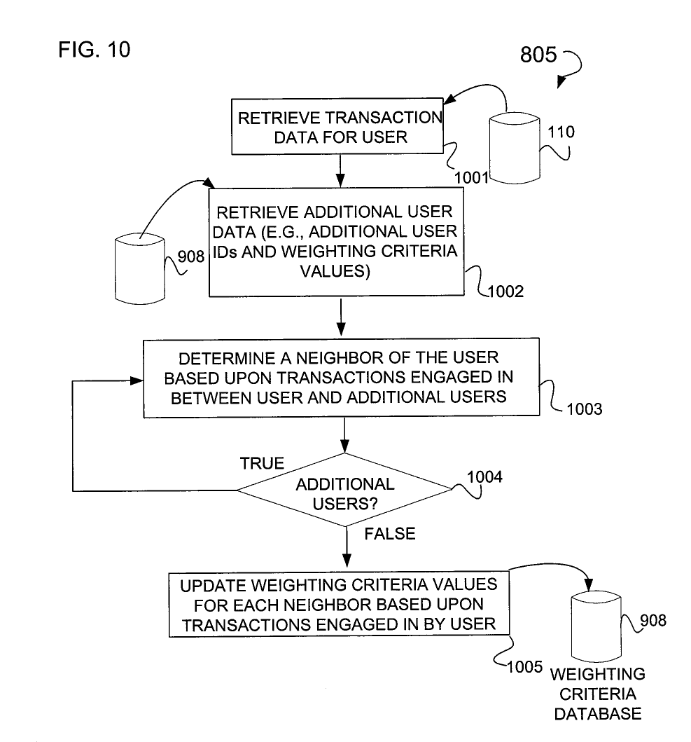

FIG. 10 is a flow chart illustrating the execution of operation 805 that propagates updates of weighting criteria values. Shown is an operation 1001 that retrieves user transaction data from the feedback and transaction database 110. An operation 1002 may be executed that retrieves additional user data such as user IDs and weighting criteria values from the weighting criteria database 908. An operation 1003 may be executed that determines a neighbor of the user based on transactions engaged in between the user and an additional or users. A decisional operation 1004 may be executed that determines whether or not additional users exist; these additional users being persons with whom the user has engaged in transactions. In cases where decisional operation 1004 evaluates to “true,” operation 1003 is re-executed. In cases where decisional operation 1004 evaluates to “false,” an operation 1005 is executed. This operation 1005 may update weighting criteria values for each neighbor of the user (e.g., additional users) based on transactions engaged in by the user. This update of weighting criteria values may then be stored into the weighting database 808.

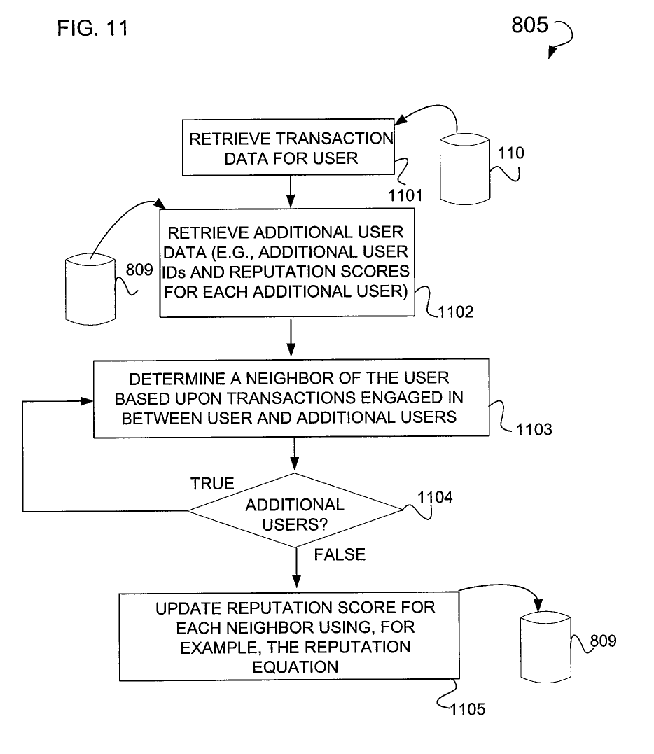

FIG. 11 is flow chart illustrating the execution of operation 805 that propagates updates of reputation scores. Illustrated is an operation 1101 that may retrieve transaction data for a user from the feedback and transaction database 110. An operation 1102 may be executed that may retrieve additional user data such as, for example, additional user IDs or reputation scores from the reputation score database 809. An operation 1103 may be executed that may determine a neighbor of the user based on transaction engaged in between the user and additional users. A decisional operation 1104 may be executed that may determine whether or not there are additional users with whom the user has transacted (e.g., transacted in the purchase or sale of goods). In cases where decisional operation 1104 evaluates to “true,” the operation 1103 is re-executed. In cases where decisional operation 1104 evaluates to “false,” an operation 1105 is executed that may update a reputation score for each user's neighbor using, for example, the reputation score equation or the reputation equation. These updated reputation scores for each neighbor may then be stored into the reputation score database 809.

In some example embodiments, operation 805 may be represented as a collective reputation equation. In one example embodiment, through the use of a matrix, a vector score value may be generated to determine a reputation score for a set of users. A vector score value may be determined by finding the product of a vector score value and an updated matrix and the values contained therein. As a threshold matter, a vector score value may be determined using the following equation:

\vec{R}=cE+cWR
where: c is a heuristic constant;
   E is a seed value containing data such as historical data, or start value data;
   W is a weighted feedback score;
   R is a reputation score.
      The vector score \vec{R} may then be used to determine a new vector score represented as \vec{R}′, where \vec{R}′ is the product of \vec{R} and a feedback matrix M The following collective reputation equation may be used to represent the generation of this product: \vec{R}*M=\vec{R}′.

FIG. 12 is an example transaction graph 1200 showing transactions between various buyers or sellers. Illustrated is a transaction graph 1200 showing buyers and sellers as nodes and transactions between the buyers or sellers as edges. A node 1201 is connected to a node 1202 via an edge 1203. This edge 1203 represents a feedback score of “−1” that the node 1201 or 1202 has received. Also shown is a node 1204 that is connected to a node 1201 via an edge 1205. The edge 1206 represents a feedback score of “−1” that the node 1201 or 1204 has received. Also shown is a node 1207 and a node 1201 connected by an edge 1206. This edge 1206 represents a feedback score which may be “−1” that the node 1201 or 1207 has received. In some example embodiments, other feedback scores of “1,” representing a positive feedback score, may also exist between nodes as represented by an edge.

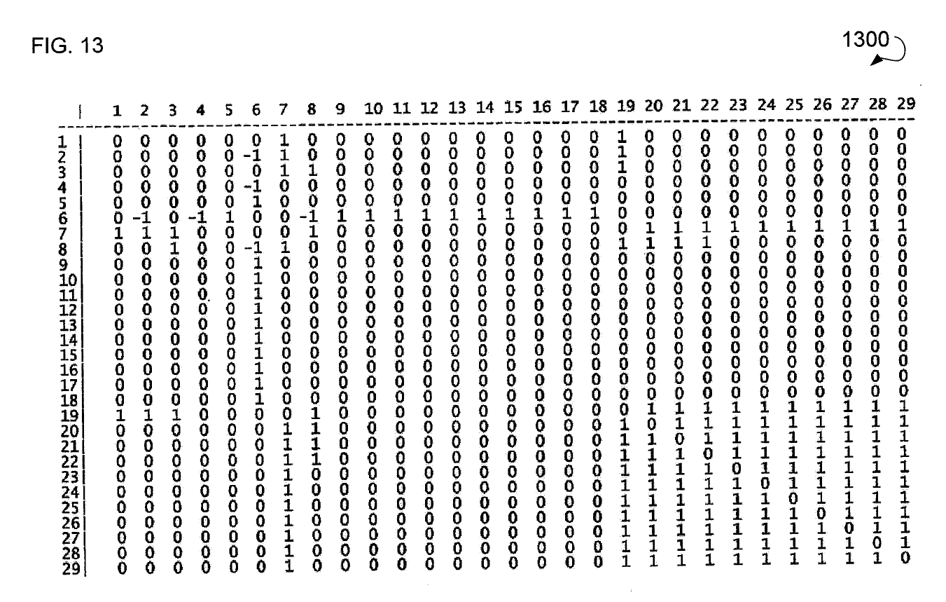

FIG. 13 is an example feedback matrix 1300 representing feedback scores for individual buyers or sellers. The feedback matrix 1300 may be an adjacency matrix. As illustrated elsewhere, the feedback scores included in the matrix may be “0”, “+1” or “−1.” The axes of this matrix may represent individual buyers or sellers, and the entries in the matrix representing the feedback scores per transaction between the parties. This matrix may be updated in real-time when this is a transaction between a buyer and seller. This feedback matrix 1300 may be stored into the feedback and transaction database 110.

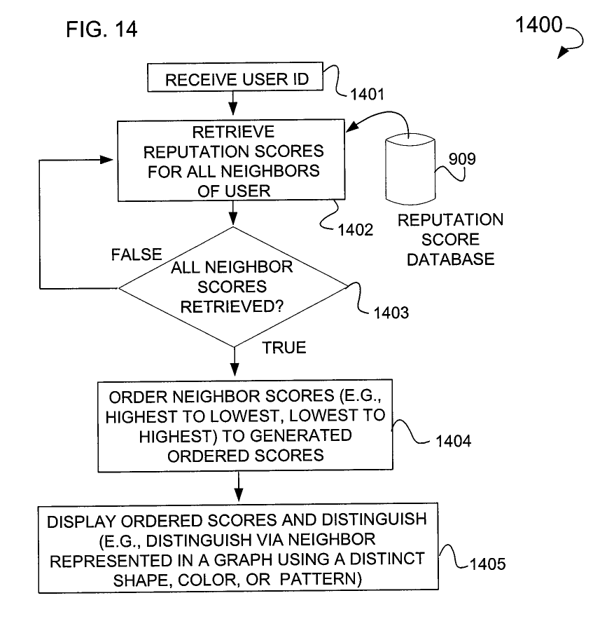

FIG. 14 is a flow chart illustrating the execution of an operation 1400 used to generate a display of a spectrum of feedback scores relating to a particular user. Shown is an operation 1401 that receives user ID. An operation 1402 may be executed that may retrieve reputation scores for all neighbors of this user from the reputation score database 909. A decisional operation 1403 may be executed that determines whether or not all neighbor scores have been retrieved. In cases where decisional operation 1403 evaluates to “false,” the operation 1402 is re-executed. In cases where decisional operation 1403 evaluates to “true,” an operation 1404 is executed that orders neighbor reputation scores to generate ordered scores. This ordering may take the form of, for example, a highest to lowest ordering, a lowest to highest ordering, or some other suitable ordering. An operation 1405 may be executed that may display these ordered scores in a graphical format and may distinguish the various scores as represented in a graphical format using one or more of distinct shapes, colors, or patterns.

### Example Storage

Some embodiments may include the various databases (e.g., 110, 908, and 909) being relational databases, or in some cases On-Line Analytical Processing (OLAP) based databases. In the case of relational databases, various tables of data are created, and data is inserted into and/or selected from these tables using Structured Query Language (SQL) or some other database-query language known in the art. In the case of OLAP databases, one or more multi-dimensional cubes or hypercubes containing multidimensional data, which data is selected from or inserted into using a Multidimensional Expression (MDX), may be implemented. In the case of a database using tables and SQL, a database application such as, for example, MYSQL™, SQLSERVER™, Oracle 8I™, 10G™, or some other suitable database application may be used to manage the data. In the case of a database using cubes and MDX, a database using Multidimensional Online Analytic Processing (MOLAP), Relational Online Analytic Processing (ROLAP), Hybrid Online Analytic Processing (HOLAP), or some other suitable database application may be used to manage the data. These tables or cubes made up of tables, in the case of, for example, ROLAP, are organized into a RDS or Object Relational Data Schema (ORDS), as is known in the art. These schemas may be normalized using certain normalization algorithms so as to avoid abnormalities such as non-additive joins and other problems. Additionally, these normalization algorithms may include Boyce-Codd Normal Form or some other normalization or optimization algorithm known in the art.

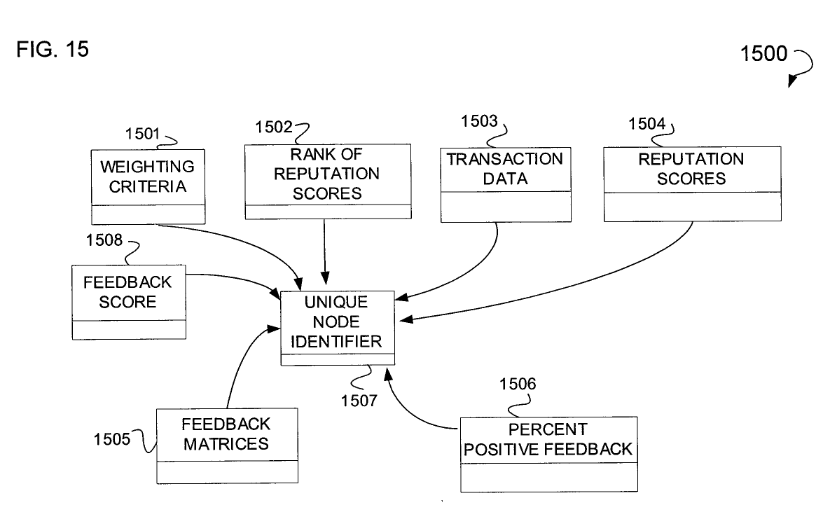

FIG. 15 is an example RDS 1500 showing various data tables that may be used by the system of method shown herein. Shown is a table 1501 that contains weighting criteria. These weighting criteria may include, for example, the value of a transaction, the length of time a user or neighbor has been a buyer or seller, or the frequency of transactions engaged in by a user or some other suitable weighting criteria. In some example embodiments, a Boolean data type may be used to denote which weighting criteria may be used wherein this Boolean value is stored into the table 1501. Further, in some example embodiments, a HyperText Markup Language (HTML) data type may be used to store weighting criteria into the table 1501. Also shown is a table 1502 that contains the ranking of various reputation scores. This ranking is may be stored as various integer values into the table 1502. Also shown is a table 1503 that contains transaction data. This transaction data may include the sellers or buyers involved in a transaction, the amount of the transaction, the time period the transaction occurred, and other suitable information. An eXtensible Markup Language (XML) data type may be used to store this transaction data into the table 1503. Also shown is a table 1504 that contains reputation scores. These reputation scores may be generated through the use of, for example, the previously referenced reputation equation and stored as integer values into the table 1504. Also shown is a table 1505 containing one or more feedback matrices, an XML data type or Binary Large Object (BLOB) may be used to store these feedback matrices into the table 1505. Also shown is a table 1506 that contains a percent positive feedback value. This percent positive feedback value may be, for example, a flow, double, or other suitable data type. A table 1508 is shown that contains feedback scores. These feedback scores may be stored as an integer, boolean, or other suitable data type. A table 1507 may be used to uniquely identify each of the entries in the previously referenced tables 1501 through 1506, and 1508. An integer or other suitable data type may be used by the unique identifier values contained in the table 1507.

### A Three-Tier Architecture

In some embodiments, a method is described as implemented in a distributed or non-distributed software application designed under a three-tier architecture paradigm, whereby the various components of computer code that implement this method may be categorized as belonging to one or more of these three tiers. Some embodiments may include a first tier as an interface (e.g., an interface tier) that is relatively free of application processing. Further, a second tier may be a logic tier that performs application processing in the form of logical/mathematical manipulations of data inputted through the interface level, and communicates the results of these logical/mathematical manipulations to the interface tier and/or to a backend or storage tier. These logical/mathematical manipulations may relate to certain business rules, or processes that govern the software application as a whole. A third, storage tier, may be a persistent or non-persistent storage medium. In some cases, one or more of these tiers may be collapsed into another, resulting in a two-tier or even a one-tier architecture. For example, the interface and logic tiers may be consolidated, or the logic and storage tiers may be consolidated, as in the case of a software application with an embedded database. This three-tier architecture may be implemented using one technology, or as will be discussed below, a variety of technologies. This three-tier architecture, and the technologies through which it is implemented, may be executed on two or more computer systems organized in a server-client, peer-to-peer, or some other suitable configuration. Further, these three tiers may be distributed between more than one computer system as various software components.

### Component Design

Some example embodiments may include the above described tiers, and processes or operations that make them up, as being written as one or more software components. Common to many of these components is the ability to generate, use, and manipulate data. These components, and the functionality associated with each, may be used by client, server, or peer computer systems. These various components may be implemented by a computer system on an as-needed basis. These components may be written in an object-oriented computer language such that a component oriented, or object-oriented programming technique can be implemented using a Visual Component Library (VCL), Component Library for Cross Platform (CLX), Java Beans (JB), Enterprise Java Beans (EJB), Component Object Model (COM), Distributed Component Object Model (DCOM), or other suitable technique. These components may be linked to other components via various Application Programming interfaces (APIs), and then compiled into one complete server, client, and/or peer software application. Further, these APIs may be able to communicate through various distributed programming protocols as distributed computing components.

### Distributed Computing Components and Protocols

Some example embodiments may include remote procedure calls being used to implement one or more of the above described components across a distributed programming environment as distributed computing components. For example, an interface component (e.g., an interface tier) may reside on a first computer system that is located remotely from a second computer system containing a logic component (e.g., a logic tier). These first and second computer systems may be configured in a server-client, peer-to-peer, or some other suitable configuration. These various components may be written using the above-described object-oriented programming techniques and can be written in the same programming language or in different programming languages. Various protocols may be implemented to enable these various components to communicate regardless of the programming language(s) used to write them. For example, a component written in C++ may be able to communicate with another component written in the Java programming language through use of a distributed computing protocol such as a Common Object Request Broker Architecture (CORBA), a Simple Object Access Protocol (SOAP), or some other suitable protocol. Some embodiments may include the use of one or more of these protocols with the various protocols outlined in the Open Systems Interconnection (OSI) model, or the Transmission Control Protocol/Internet Protocol (TCP/IP) protocol stack model for defining the protocols used by a network to transmit data.

### A System of Transmission Between a Server and Client

Some embodiments may use the Open Systems Interconnection (OSI) basic reference model or Transmission Control Protocol/Internet Protocol (TCP/IP) protocol stack model for defining the protocols used by a network to transmit data. In applying these models, a system of data transmission between a server and client, or between peer computer systems is described as a series of roughly five layers comprising: an application layer, a transport layer, a network layer, a data link layer, and a physical layer. In the case of software having a three-tier architecture, the various tiers (e.g., the interface, logic, and storage tiers) reside on the application layer of the TCP/IP protocol stack. In an example implementation using the TCP/IP protocol stack model, data from an application residing at the application layer is loaded into the data load field of a TCP segment residing at the transport layer. The TCP segment also contains port information for a recipient software application residing remotely. The TCP segment is loaded into the data load field of an IP datagram residing at the network layer. Next, the IP datagram is loaded into a frame residing at the data link layer. This frame is then encoded at the physical layer, and the data is transmitted over a network such as the Internet, Local Area Network (LAN), Wide Area Network (WAN), or some other suitable network. In some cases, the word “internet” refers to a network of networks. These networks may use a variety of protocols for the exchange of data, including the aforementioned TCP/IP. These networks may be organized within a variety of topologies (e.g., a star topology) or structures.

### A Computer System

FIG. 16 shows a diagrammatic representation of a machine in the example form of a computer system 1600 within which a set of instructions for causing the machine to perform any one or more of the methodologies discussed herein may be executed. A server may be a computer system. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a Personal Computer (PC), a tablet PC, a Set-Top Box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Example embodiments can also be practiced in distributed system environments where local and remote computer systems that are linked (e.g., either by hardwired, wireless, or a combination of hardwired and wireless connections) through a network both perform tasks. In a distributed system environment, program modules may be located in both local and remote memory-storage devices (see below).

The example computer system 1600 includes a processor 1602 (e.g., a Central Processing Unit (CPU), a Graphics Processing Unit (GPU) or both), a main memory 1601 and a static memory 1606, which communicate with each other via a bus 1608. The computer system 1600 may further include a video display unit 1610 (e.g., a Liquid Crystal Display (LCD) or a Cathode Ray Tube (CRT)). The computer system 1600 also includes an alphanumeric input device 1656 (e.g., a keyboard), a User Interface (UI) cursor controller 1611 (e.g., a mouse), a disk drive unit 1616, a signal generation device 1653 (e.g., a speaker) and a network interface device (e.g., a transmitter) 1620.

The disk drive unit 1616 includes a machine-readable medium 1646 on which is stored one or more sets of instructions 1617 and data structures (e.g., software) embodying or used by any one or more of the methodologies or functions described herein. The software may also reside, completely or at least partially, within the main memory 1601 and/or within the processor 1602 during execution thereof by the computer system 1600, the main memory 1601 and the processor 1602 also constituting machine-readable media.

The instructions 1617 may further be transmitted or received over a network 1626 via the network interface device 1620 using any one of a number of well-known transfer protocols (e.g., Hyper Text Transfer Protocol (HTTP), Secure Hyper Text Transfer Protocol (HTTPS)).

In some embodiments, a removable physical storage medium is shown to be a single medium, and the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding, or carrying a set of instructions for execution by the machine and that cause the machine to perform any of the one or more of the methodologies described herein. The term “machine-readable medium” shall accordingly be taken to include, but not be limited to, solid-state memories, optical and magnetic media, and carrier wave signals.

### Market Place Applications

Some example embodiments may include, the use of reputation scores propagated in real-time amongst buyers or sellers who have transacted in good or services between one another. These buyer or sellers may be considered neighbors. In one example embodiment, a transaction engaged in by a buyer or seller may change not only the buyer or sellers reputation score, but this change in reputation score may propagate to those who are neighbors of the buyer or seller. This propagation may allow for a way to evaluate those providing feedback for a buyer or seller.

The Abstract of the Disclosure is provided to comply with 37 C.F.R. §1.72(b), requiring an abstract that allows the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A computer implemented method comprising:
receiving a feedback score relating to a transaction engaged in by a user;
applying a weight to the feedback score based on weighting criteria to create a weighted feedback score; and
generating a reputation score for the user based on the weighted feedback score.

2. The computer implemented method of claim 1, further comprising updating a reputation score of a neighbor of the user using the reputation score for the user, the neighbor including another user with whom the user has engaged in a transaction.

3. The computer implemented method of claim 1, further comprising:
identifying a weighted feedback score for at least one neighbor, the at least one neighbor including another user with whom the user has engaged in a transaction;
determining a sum of the weighted feedback score for the at least one neighbor; and
identifying the reputation score for the user by determining a sum of the weighted feedback score for the at least one neighbor and a seed value.

4. The computer implemented method of claim 1, wherein the weighting criteria includes at least one of a qualification of another user, a monetary value of a transaction engaged in by another user, or a frequency of transactions conducted by another user.

5. The computer implemented method of claim 1, further comprising determining a vector score through finding a product of a further vector score and a feedback matrix, the feedback matrix including at least one feedback score for at least one user.

6. The computer implemented method of claim 5, wherein the further vector score includes a product of the weighted feedback score and the reputation score.

7. The computer implemented method of claim 5, wherein the feedback matrix is an adjacency matrix.

8. A computer implemented method comprising:
identifying a reputation score relating at least one neighbor of a user, the at least one neighbor of the user including another user with whom the user has engaged in a transaction;
ordering the reputation score relating to at least one neighbor of the user to create an ordered reputation score; and
displaying the ordered reputation score.

9. The computer implemented method of claim 8, wherein the ordering includes ordering the reputation score in an order including at least one of ordering by highest to lowest reputation score, or ordering by lowest to highest reputation score.

10. The computer implemented method of claim 8, further comprising displaying a graph that includes a node and an edge, the node including the reputation score relating to the at least one neighbor, and the node and the edge distinguished by at least one distinguishing characteristic including a color, a shape, or a pattern.

11. A computer system comprising:
a receiver to receive a feedback score relating to a transaction engaged in by a user;
a weighting engine to apply a weight to the feedback score based on weighting criteria to create a weighted feedback score; and
a reputation score generator to generate a reputation score for the user based on the weighted feedback score.

12. The computer system of claim 11, further comprising a reputation score update engine to update a reputation score of a neighbor of the user using the reputation score for the user, the neighbor includes another user with whom the user has engaged in a transaction.

13. The computer system of claim 11, further comprising:
a first identification engine to identify a weighted feedback score for at least one neighbor, the at least one neighbor that includes another user with whom the user has engaged in a transaction;
a calculation engine to determine a sum of the weighted feedback score for the at least one neighbor; and
a second identification engine to identify the reputation score for the user through a determination of a sum of the weighted feedback score for the at least one neighbor and a seed value.

14. The computer system of claim 11, wherein the weighting criteria includes at least one of a qualification of another user, a monetary value of a transaction engaged in by another user, or a frequency of transactions conducted by another user.

15. The computer system of claim 11, further comprising a vector score engine to determine a vector score through finding a product of a further vector score and a feedback matrix, the feedback matrix including at least one feedback score for at least one user.

16. The computer system of claim 15, wherein the further vector score includes a product of the weighted feedback score and the reputation score.

17. The computer system of claim 15, wherein the feedback matrix is an adjacency matrix.

18. A computer system comprising:
a reputation score engine to identify a reputation score relating at least one neighbor of a user, the at least one neighbor of the user that includes another user with whom the user has engaged in a transaction;
an ordering engine to order the reputation score that relates to at least one neighbor of the user to create an ordered reputation score; and
a display to display the ordered reputation score.

19. The computer system of claim 18, wherein the order includes the reputation score in an order including at least one of an order by highest to lowest reputation score, or ordering by lowest to highest reputation score.

20. The computer system of claim 18, further comprising a display to display a graph that includes a node and an edge, the node to include the reputation score for at least one neighbor, and the node and the edge distinguished by at least one distinguishing characteristic that includes a color, a shape, or a pattern.

21. An apparatus comprising:
means for receiving a feedback score relating to a transaction engaged in by a user;
means for applying a weight to the feedback score based on weighting criteria to create a weighted feedback score; and
means for generating a reputation score for the user based on the weighted feedback score.

22. A machine-readable medium comprising instructions, which when implemented by one or more machines, cause the one or more machines to perform the following operations:
receive a feedback score relating to a transaction engaged in by a user;
apply a weight to the feedback score based on weighting criteria to create a weighted feedback score; and
generate a reputation score for the user based on the weighted feedback score.
